(19) United States
(12) Patent Application Publication
(10) Pub. No.: US 2024/0059055 A1
(43) Pub. Date: Feb. 22, 2024

(54) LAMINATE

(71) Applicant: Dow Global Technologies LLC, Midland, MI (US)

(72) Inventor: Abraham Barretto, Juinagar (IN)

(21) Appl. No.: 17/754,520

(22) PCT Filed: Oct. 1, 2020
(86) PCT No.: PCT/US2020/053721

§ 371 Date: Apr. 5, 2022

(30) Foreign Application Priority Data
Oct. 18, 2019 (IN) 201941042250

(51) Int. Cl. B32B 27/12; B32B 27/32; B32B 5/02; B32B 7/12; B32B 37/12; B65D 65/40

(52) U.S. Cl. CPC B32B 27/12; B32B 27/32; B32B 5/024; B32B 7/12; B32B 37/1284; B65D 65/40; B32B 2262/0253; B32B 2307/75; B32B 2307/518; B32B 2255/26; B32B 2255/10; B32B 2255/02; B32B 2305/188; B32B 2323/10; B32B 2439/46; B32B 2439/70; B32B 2307/748; B32B 2307/582; B32B 2250/02

(57) ABSTRACT

A multi-layer laminate product including: (a) a first polyolefin film substrate layer; (b) a second woven polyolefin fabric substrate layer; and (c) a layer of a solventless (or solvent-free) laminating adhesive composition disposed on the surface of at least one of the layers of (a) and (b) for binding layers (a) and (b); and a process for manufacturing the above laminate.

### FIELD

The present invention is related to a multi-layer laminate structure; and more specifically, the present invention is related to a multi-layer laminate including (a) at least a first layer of an oriented polypropylene film; (b) at least a second layer of a woven polypropylene fabric; and (c) a solventless lamination adhesive composition for bonding the oriented polypropylene film to the woven polypropylene fabric.

### BACKGROUND

The laminates of woven polypropylene (wovenPP) or woven high density polyethylene (wovenHDPE) are usually intended to package bulk quantities of consumer goods like food grain, pulses, sugar, vegetables, dry foodstuff, and the like. Typically, these types of laminates are prepared by an extrusion lamination process, where a thin polyethylene (PE) layer is extruded between the printed biaxially oriented polypropylene (BOPP) film and the wovenPP film, to act as a tie layer. The drawback with such an extrusion lamination process is that the bond values between the two laminated films are low (below 150 g/15 mm) and the cost of lamination is high, since approximately 10 gsm to 15 gsm of extruded PE is employed in this process. Using an adhesive lamination, the bond values are normally higher (e.g., above 150 g/15 mm) and the cost of lamination is lower, since only 2.5 gsm to 4.5 gsm of solventless adhesive is employed for an adhesive lamination structure. In addition, the speed of extrusion lamination is slow (e.g., 120 mpm to 150 mpm); whereas, with a solventless adhesive lamination, the speed of processing is usually higher (e.g., from 200 mpm to 400 mpm). Therefore, the productivity of a solventless adhesive lamination route can be beneficially higher.

However, it is difficult to generally process laminates of wovenPP or wovenHDPE, by an adhesive lamination process since the wovenPP surface is highly uneven and slightly porous. As an alternative to an extrusion lamination, a solvent-based adhesive lamination process has been used. For example, solvent-based adhesive lamination process and machine has been used for laminating oriented polypropylene (OPP) and vacuum metalized oriented polypropylene (VMOPP) to form an OPP/VMOPP film lamination; but not for manufacturing heavy duty sacks. It becomes even more challenging to carry out an adhesive lamination process with a solventless adhesive system, as solventless adhesives tend to have a very low green bond value (e.g., <20 g/15 mm).

Therefore, it would be desirable for those in the industry to overcome the challenges pertaining to general solventless adhesive lamination, by providing an adhesive system that has a very rapid bond development (molecular build-up after mixing the two components). Also, a mixed adhesive having a low initial viscosity, helps in wetting the rough uneven wovenPP surface, evenly. The rapid bond development of an adhesive helps in binding and holding the two films together. Additionally, it would be desirous for the adhesive to have sufficient initial tack/bond/shear and quick cure rate in order to hold the thick wovenPP film and a printed BOPP film together and to prevent any air from entering the freshly laminated layers which can cause micro de-lamination or tunneling.

It is also important that a finished laminate be able to withstand a drop test, where the laminate converted into a 10 kg or 25 kg sack and filled with food grain, or similar items is sealed and dropped at least six separate times (once on each flat surface of the sack including the front, back top, bottom, and each side of the sack) from a height of about 1.8 m.

Heretofore, various laminate structures and manufacturing processes preparing laminates and packaging articles have been disclosed in the prior art such as in U.S. Pat. Nos. 8,377,508B2 and 10,233,368B2; and U.S. Patent Application Publication Nos. US20130177747A1; US20150360449A1; US20180281370A1; and US20180186130A1. However, the above prior art discloses manufacturing composite films in general for general flexible packaging applications; or using an adhesive to laminate a thermoplastic film to a non-woven thermoplastic fabric by heat pressing. None of the above prior art discloses a fast cure solventless adhesive system for laminating wovenPP fabric or wovenHDPE fabric for heavy duty packaging or manufacturing OPP/wovenPP laminates for heavy duty packaging.

### SUMMARY

In one embodiment, the present invention is directed to a multi-layer laminate structure including (a) at least a first layer of a polymer film bonded to (b) at least a second layer of a woven fabric with (c) a solventless (i.e., solvent-free) lamination adhesive system or composition for bonding the first layer of polymer film to the second layer of woven fabric.

In a preferred embodiment, the solventless lamination adhesive composition, component (c), used in the present invention advantageously provides a green bond (bond after 60 minutes [min] of lamination) of above 50 g/15 mm between the at least first layer of polymer film and the at least second layer of woven fabric; and provides an accelerated rate of cure giving cured bonds in excess of 150 g/15 mm within 8 hr of lamination.

In another preferred embodiment, the at least first layer of polymer film, component (a), includes for example, a printed biaxially oriented polypropylene (BOPP) film layer; and the at least second layer of woven fabric, component (b), includes for example, a wovenPP layer or a wovenHDPE layer to form the laminate of the present invention. using the solventless adhesive system.

In another embodiment, the present invention includes an adhesive lamination process for manufacturing the above multi-layer laminate structure.

In still another embodiment of the present invention is directed to a packaging article made using the above laminate.

In yet another embodiment, the present invention includes a process for manufacturing the above packaging article.

### DETAILED DESCRIPTION

As used throughout this specification, the abbreviations given below have the following meanings, unless the context clearly indicates otherwise: “=” means “equal to”; “@” means “at”; “adh” means “adhesive”; “ex” means “extrusion”; “<” means “less than”; “>” means “greater than”; N=Newton; mN=millinewton(s); N/15 mm=Newton(s) per 15 millimeter(s); mpm=meter(s) per minute; gsm=gram(s) per square meter; g=gram(s); g/15 mm=gram(s) per 15 millimeter(s); mg=milligram(s); kg=kilogram(s); kg/m³=kilogram(s) per cubic meter; L=liter(s); mL=milliliter(s); g/L=gram(s) per liter; rpm=revolution(s) per minute; Mw=molecular weight; m=meter(s); μm=micron(s); μL=microliter(s); mm=millimeter(s); cm=centimeter(s); min=minute(s); s=second(s); hr=hour(s); rad/s=radian per second; ° C.=degree(s) Celsius; A=Ampere; Kw·min/m²=kilowatt·minute per square meter(s); mPa·s=millipascal(s)-second(s); kPa=kilopascal(s); Pa·s/m²=pascal(s)-second(s) per meter squared; dtex or Decitex=gram(s) per 10,000 meters; cN=centinewton; mm²=millimeter(s) squared; mg KOH/g=hydroxyl value in terms of milligrams of potassium hydroxide per gram of polyol; cells/mm² is pore density value in terms of the number of cells per millimeter squared; %=percent; vol %=volume percent; and wt %=weight percent.

All percentages stated herein are weight percentages (wt %), unless otherwise indicated.

Temperatures are in degrees Celsius (° C.), and “ambient temperature” means between 20° C. and 25° C., unless specified otherwise.

“Multi-layer” means two or more layers wherein at least two of the layers are of different substrates.

The terms “solventless”, “non-solvent” or “solvent-free” are used herein interchangeably to mean a substance that contains little or no solvent; and with reference to an adhesive composition herein, the composition contains <2 wt % solvent in one embodiment and from 0 wt % to <1 wt % in another embodiment. In a preferred embodiment, the composition contains zero wt % solvent as diluent or additive; and the concentration of solvent present, if any, in the composition is considered herein to be due to contaminant levels of, for example, <500 ppm. The solvent-free adhesive of the present invention is environmentally friendly.

In a broad embodiment, the present invention includes a multi-layer laminate structure for producing laminated packaging materials; wherein the laminate includes the combination of at least two layers of substrates adhered together by an adhesive composition or formulation layer. For example, in a general embodiment of the present invention includes a multi-layer laminate including (a) at least a first layer of an oriented polyolefin film such as an OPP film; (b) at least a second layer of a woven polyolefin fabric such as a wovenPP fabric; and (c) a solventless lamination adhesive composition for bonding the oriented polyolefin film to the woven polyolefin fabric. One or more other optional layer substrates can be used to produce the above multi-layer laminate structure, if desired.

The polyolefin film first layer, component (a), used for making the laminate of the present invention can include one or more polyolefins. For example, the polyolefin first layer, can include one or more polyolefin films such as high density polyethylene (HDPE), biaxially oriented polyethylene (BOPE), biaxially oriented polypropylene (BOPP), metalized BOPE, metalized BOPP, low density polyethylene (LDPE), and polyethylene terephthalate (PET).

In one preferred embodiment, the polyolefin film first layer can include, for example, a printed BOPP film layer or PET film layer which is bonded to the woven fabric second layer.

The thickness of the polyolefin film first layer used to form the multi-layer laminate of the present invention can be, for example, from 8 μm to 20 μm in one embodiment and from 12 μm to 15 μm in another embodiment.

The woven polyolefin fabric second layer, component (b), is bonded to the polyolefin film first layer described above utilizing a lamination adhesive for laminating (bonding) the polyolefin film first layer and the woven fabric second layer together. The woven polyolefin fabric second layer used for making the laminate of the present invention can include, for example, one or more woven polyolefin fabrics. For example, the woven polyolefin fabric second layer, can include one or more polyolefin fabrics such as a wovenPP layer and a wovenHDPE layer.

The weight of woven polyolefin fabric second layer is generally in the range of from 35 gsm to 110 gsm in one embodiment; and from 50 gsm to 90 gsm in another embodiment. If the weight of the fabric is <35 gsm, the material will not withstand the drop test of a heavy-duty sack made using the fabric, and if the weight of the fabric is >110 gsm, the use of the fabric may no longer be economically viable.

The layer of adhesive composition, component (c), used to bind the first and second layers, components (a) and (b), respectively, is a lamination adhesive that can advantageously provide a green bond (bond after 60 min of lamination) of above 50 g/15 mm between the at least a first layer film and the at least a second layer woven fabric; and provides an accelerated rate of cure giving cured bonds in excess of 150 g/15 mm within 8 hr of lamination.

Exemplary of the adhesive composition useful in the present invention are the adhesives described in U.S. Patent Application Publication No. US 2019/0127617 A1 which include two-component solventless polyurethane-based adhesive compositions comprising an isocyanate component and a polyol component. For example, the isocyanate component can be an isocyanate such as MOR-FREE™ 698A (available from The Dow Chemical Company) and the polyol component can be a polyol such as MOR-FREE™ C-83 (also available from The Dow Chemical Company) as described in the above patent application publication. The process of producing the adhesive composition used in the present invention is also described in the above patent application publication.

In another preferred embodiment, the adhesive can include commercially available adhesives including, for example, MOR-FREE™ 899A/C99 (available from The Dow Chemical Company).

The thickness of the adhesive layer used to bond the first and second layers and to form the multi-layer laminate of the present invention can be, for example, from 2.5 gsm to 4.5 gsm in one general embodiment. If the thickness of the adhesive layer is <2.5 gsm, a low adhesion bond will result using the adhesive; and if the thickness of the adhesive layer is >4.5 gsm, it may be practically difficult to apply the adhesive to the first and second layers.

The minimum bond value of the adhesive, after 60 min of lamination, is from 50 g/15 mm to 100 g/15 mm in one general embodiment. It has been observed that if the green 60 min bond is below 50 g/15 mm, the final bond of the first and second layers is also likely to be low and unacceptable; and if the 60 min bond is >100 g/15 mm, most probably a good and high final cured bond will occur but there is no further gain economically to use a 60 min bond of >100 g/15 mm.

The final bond value of the adhesive, after adhesive cure, is >150 g/15 mm in one general embodiment; and between 150 g/15 mm to 250 g/15 mm in another embodiment. Any bond values above 250 g/15 mm are considered to be super good; but final bond values below 100 g/15 mm are not acceptable and will result in a drop test failure.

The adhesive useful in the present invention has several advantages compared to other known lamination adhesives including, for example, the adhesive has superior performance with respect to flexibility/impact by not permitting any de-lamination between the webs the packaging process of bulk goods and when performing a drop test.

As aforementioned, the multi-layer laminate can include other optional layered substrates, component (d), in addition to the above component layers (a)-(c). For example, substrates such as OPA i.e. oriented polyamide (Nylon), cellophane, and PET may be laminated (bonded) to the above first and second layers.

The multi-layer laminate of the present invention is produced by applying the adhesive composition described above onto the surface of the first film substrate to form an adhesive layer on the surface of the film substrate; then contacting the adhesive coated first film substrate with the second woven fabric substrate; and then curing the multi-layer laminate.

The application of the adhesive composition can be carried out by conventional means known in the art of applying adhesive compositions or formulation. For example, the adhesive composition can be applied using conventional equipment and processes, including rolling, spraying, hot melt extrusion and the like.

For example, a laminator such as a Nordmeccanica 1 Shot laminator (available from Nordmeccanica) can be used with an adhesive such as SYMBIEX™ (a non-conventional adhesive technology available from The Dow Chemical Company), to prepare laminates of the present invention. The 1 Shot technology refers to a solventless lamination technology from Nordmeccanica which is typically used with the SYMBIEX adhesive. The 1 Shot technology involves an adhesive composition including an adhesive component and a hardener component wherein the components are not mixed together before application of the adhesive composition; but instead, wherein the components are applied separately on individual films substrates.

In a general embodiment, the process for producing a multi-layer laminate includes, for example, the steps of in the following order:
(I) providing: (a) a first film substrate, (b) a second woven fabric substrate; and (c) an adhesive composition;
(II) applying the adhesive composition to at least a portion of the surface of the first or second substrate to form an adhesive layer;
(III) combining the first and second substrates together with the adhesive layer, sufficient to form a multi-layer laminate; and
(IV) curing the structure of step (III) to form a multi-layer laminate.

In carrying out Step (I), the web unwind tension is maintained at a minimum to prevent any stretching or curling of the web. The web tension for printed OPP or PET film may be maintained around 40 N-120 N. A web tension below 40 N may not be sufficient to pull the primary film along the length of the laminator. A web tension above 120 N may result in the stretching of the web.

In carrying out Step (II), the adhesive composition is supplied “warm”, i.e. between 30° C. to 60° C. in one embodiment, and the application rollers are also maintained between these temperatures to facilitate the spread of the adhesive over the web. The coating nip pressure is usually maintained in a range of from 2 bar to 5 bar (kg/sq·cm) in one embodiment. At an application temperature of <30° C. and a pressure of <2 bar, the adhesive will not spread uniformly over the web and will fail to wet the web surface evenly, resulting in a low bond value for the adhesive. With higher temperature, the adhesive or rollers may soften the web and this may lead to improper web tension control and stretching on the laminator. Pressures of >5 bar are difficult to achieve on a conventional laminator from standard compressed air line systems; and using pressures >5 bar is really not necessary for the application of adhesive.

In carrying out Step (III), the laminating nip roller is maintained between 25° C. and 55° C. to facilitate the spread of the adhesive over the secondary web. The laminating nip pressure is usually maintained in a range of from 2 bar to 5 bar (kg/sq·cm) in one embodiment. At an application temperature of <25° C. and a pressure of <2 bar, the adhesive will not spread uniformly over the secondary web; and the adhesive will fail to wet the secondary web surface evenly, resulting in low bond values. By using a temperature of >55° C., the adhesive may soften so much that the adhesive may penetrate the woven material through the woven material's pores. This, in turn, may lead to a low adhesive coating between the films, resulting in a thinner tie layer and eventually resulting in low bond values. Using a pressure of >5 bar for the laminating nip pressure will also have the same effect of adhesive penetrating the woven web and eventually resulting in low bond values.

In carrying out Step (IV), the freshly made laminate roll is fastened by self-adhesive tape to avoid opening or loosening of the roll's tension. The laminate structure is cured by keeping the laminate structure suspended in air at an ambient temperature of between 20° C. and 40° C. for a period of 24 hr in one embodiment.

In another embodiment, a further optional processing step can be carried out once the laminate is cured including, for example, a step of slitting the cured laminate. The slitting step is typically carried out after the laminate is subjected to a period of curing time such as after a period of curing time of 24 hr or more in one general embodiment, and from 12 hr to 24 hr after lamination in another embodiment. The cured laminate may be slit at an ambient temperature of from 20° C. to 40° C. in one embodiment.

After the slitting of the laminate step, bags can be manufactured from the slitted laminate material using any conventional process and equipment known for bag making. For example, the bag making process may include the steps of: (i) filling a cement into the laminate on a VFFS (vertical form fill and seal) machine using ultrasonic sealing/welding technology; and forming the laminate into a 50 kg bag where the edges of the bag are sealed ultrasonically. A description of a method and apparatus for ultrasonic sealing can be found in U.S. Pat. No. 8,028,503 B2; in U.S. Pat. No. 9,149,980 B2 and at the following internet website: https://www.herrmannultraschall.com/en/ultrasonic-basics/ultrasonic-sealing/.

The manufactured bags can then be subjected to a drop test as described herein in the Examples.

The resulting multi-layer laminate produced according to the above described process, can exhibit several advantageous properties including, for example, the final laminate: (1) does not undergo de-lamination; (2) has a bond value in excess of 150 g/15 mm; (3) shows tear values in excess of 42,000 mN; and (4) passes the drop test.

For example, the final laminate of the present invention has a bond value in excess of 150 g/15 mm between the two laminated films (the first and second layers) in one embodiment as described above.

The final laminate of the present invention exhibits a tear value in excess of 42,000 mN in one general embodiment and from >42,000 mN to 50,000 mN in another embodiment.

In addition, the final laminate of the present invention passes the drop test, particularly when: (i) the laminate is constructed into a sack or pouch, (ii) the laminate pouch is filled material and heat sealed; and (iii) the filled laminate pouch is subjected to a drop on all six surfaces of the sack from a height of 1.8 m.

For example, the laminate of the present invention, when used for heavy duty packaging of food grain/pulses, passes the drop test, i.e., the laminate shows no sign of de-lamination after the packaging is manually dropped 6 separate times from a height of 1.8 m. In addition, no tunneling, de-lamination or deformation in the laminate occurs after the adhesive cures for 24 hr.

Other advantageous features and applications for the OPP/wovenPP laminate sacks include, for example: resistance to severe weathering conditions, high tensile strength, robust drop test resistance, excellent optical appearance, and resistance to spills.

The laminate of the present invention can be used in packaging applications for manufacturing various packaging materials and products. In particular, a manufacturer of wovenPP fabric and bags for bulk packaging of food grain and pulses can benefit from the present invention.

For example, the laminate can be used for solventless adhesive lamination of OPP film to wovenPP laminated sack cloth. The sack cloth can be used, for example but not to be limited thereby, for bulk packaging of food grains/pulses, seeds, lentils, cereals, sugar, salt, oilseed, sugar, salt, tea powder, onions, potatoes, other food stuff, pharmaceuticals, fertilizer, pesticides and the like.

The laminate structure using the Pacacel™ adhesive has a much higher cohesion than a laminate structure using a conventional solventless adhesive system because the adhesive of the present invention exhibits a faster bond strength build up than a conventional adhesive. And, the high cohesion is derived from high loading levels of polyester polyol content in the adhesive composition as well as from a relative high crosslink density. However, at the same time, the proper polyester polyol is selected that has an initial viscosity which is not too high. Otherwise, the adhesive application operation will be a problem. The initial viscosity of the mixed adhesive and hardener system, in the recommended ratio by weight, should preferably remain below 2,000 kPa·s for an even application on the web/film.

To address all of the above concerns, a thick uneven laminate is successfully processed on a standard solventless laminator, using a very special accelerated cure, solventless adhesive, such as PACACEL™ 968/C-108, which has low viscosity and is good for wetting the uneven wovenPP film; and at the same time, has a higher initial green tack/bond/shear compared to a conventional two-component solventless laminating adhesive, as well as an accelerated cure rate in order to generate a high enough bond value and shear strength, inhibiting any air movement between the layers of the laminate and providing enough strength to hold the films together, in the green stage. The solventless lamination process does not involve the use of high temperature on the laminator to dry solvent vapors. The entire process is carried out at room temperature and so there is extremely low probability of stretching the printed OPP films to cause any curling or related defect like wrinkle formation, in the final product.

The demand is high for printed OPP/wovenPP or OPP/wovenHDPE laminates for bulk sack packs of woven sack heavy duty packaging material laminated (coated). The converter in the manufacturing of packaging products can use the novel solventless adhesive to manufacture laminates from 12 microns thick or 15 microns thick BOPP film adhered to 70 gsm wovenPP. The coated (laminated) woven sack industry can economically utilize the solventless adhesive lamination process. For example, the manufacturing of OPP/wovenPP bags, by using the solventless adhesive lamination process of the present invention, is economical because a 10+ μm thick PE extrusion layer can be replaced with about 3.5 gsm adhesive and the production line speed can be increased.

### EXAMPLES

The following examples are presented to further illustrate the present invention in detail but are not to be construed as limiting the scope of the claims. Unless otherwise indicated, all parts and percentages are by weight.

Various ingredients, components, additives, or raw materials used in the Inventive Examples (Inv. Ex.) and the Comparative Examples (Comp. Ex.) include the following materials:
(1) PACACEL™ 968/C-108 is an adhesive and available from The Dow Chemical Company; and
(2) MOR-FREE™ 899A/C99 is an adhesive and available from The Dow Chemical Company.

General Procedure for Preparing Laminate Structures

Several laminate structures were prepared as follows: On a standard Normeccanica solventless laminator, the printed plain web of OPP or PET is taken as a primary substrate. This web gets coated with the mixed adhesive from the adhesive dam, at the adhesive coating station. This web then travels along the length of the laminator to the laminating nip, where the web gets laminated/nipped to the secondary wovenPP or wovenHDPE film. After the laminating nip, the fresh laminate is rewound into a roll at the laminator's rewind station.

Flat wovenPP fabric and tubular wovenPP fabric were each laminated with 12 microns thick OPP film and 15 microns thick OPP film; and in both cases a printed OPP film and an unprinted OPP film was used for each laminate prepared.

The laminated reels are then sent for analysis and tested for bond strength and drop test and such analysis can be done by the customer.

### Trials

Three trials were conducted with laminates using the process parameters described herein below and using PACACEL 968/C108 as the adhesive. Good results were obtained by carrying out lamination on a pilot scale using a Nordmeccanica Super Combi 3000 Laminator machine and mixer (both pieces of equipment manufactured and available from Nordmeccanica SpA). The Laminator machine was used to apply a layer of PACACEL 968/C108 adhesive (coated material) onto a web (support) of wovenPP fabric and to laminate a printed or unprinted OPP film onto the wovenPP fabric. The adhesive cures quickly and strongly binds the OPP film to the uneven, wovenPP fabric. The resultant multilayer laminate of OPP film laminated to the wovenPP fabric is referenced as follows: “OPP//wovenPP fabric”.

In the trials, a mix ratio of the isocyanate (NCO) component, PACACEL 968, to the polyol (OH) component, C108, was maintained at 100:45.8 parts by weight.

The temperature of the tank containing the NCO component was maintained at 45° C.; and the temperature of the tank containing the OH component was maintained at 35° C. The temperature of the hose pipe attached to the Nordmeccanica mixer was maintained at 40° C. The Laminator's metering steel rollers, referenced as “S1” and “S2”, were maintained at 40° C. The coating roller, referenced as “S3”, was maintained at 45° C.; and the laminating nip roller, referenced as “S4”, was maintained at 55° C. The adhesive temperature in the adhesive dam was 43° C.

A pressure of 4 bar (400,000 pascals) was used in the trials for each of the following: the Laminator's Transfer pressure, the coater's pressure, the laminating nip pressure, and the lay-on pressure.

For the corona treatment of the wovenPP film, the in-line corona of 2.5 Kw·min/m² was maintained.

### Example 1—Trial 1

A 15 μm printed OPP//70 gsm wovenPP flat fabric was used in this Trial 1. The food stuff used to fill the resultant bags made from the laminate was rice sold under the brand name of Amul Gold Rice.

The tensions used were as follows: a primary tension on the web of the laminator was 120 N, a bridge tension was 140 N, a secondary tension was 270 N, a rewind tension was 150 N, and a taper tension was 15%.

The adhesive coating weight was maintained between 3.5 gsm-3.8 gsm. The line speed of the lamination was maintained at 200 mpm. The current of the coater, @ 200 mpm line speed, was maintained at 5.0 A to 6.0 A. The 24 hr bond of the laminate produced in this Trial 1 was measured at 100 g/15 mm to 200 g/15 mm (1 N/15 mm to 2 N/15 mm); and the tests performed on the laminate resulted in a smooth peel and a partial ink transfer.

A “smooth peel” herein means a cohesive failure between the two laminated webs without any one of the two webs getting damaged or tearing apart during testing. “Failure” could include a cohesive failure of the adhesive layer; a transfer of the printing inks on to the opposite web; or an adhesion failure between the adhesive and one of the films.

A “partial ink transfer” herein means a portion of the printing ink on a printed film surface is transferred from the printed film surface on to the opposite woven web. The failure mode observation while checking the bond strength is critical to understand the extent of bonding between the two webs/films. While the bond values are recorded by a number, for example 1 N/15 mm, a cohesive failure indicates that the bond strength is around 1 N/15 mm and not higher. A partial or complete ink transfer indicates that the bond values are restricted to a certain level due to the limited bonding of the printing ink to the film. However, if a substrate failure bond occurs, with the same value of 1 N/15 mm, it indicates that the actual bond strength between the two laminated films is in excess of 1 N/15 mm, but one of the substrates de-laminates or tears, at the force of 1 N/15 mm.

### Example 2—Trial 2

A 12 μm unprinted OPP//70 gsm wovenPP tubular fabric was used in this Trial 2.

The tensions used in this Trial 2 were as follows: a primary tension on the web of the laminator was 40 N, a bridge tension was 80 N, a secondary tension was 100 N, a rewind tension was 120 N, and a taper tension was 15%.

The adhesive coating weight maintained was between 3.5 gsm and 3.8 gsm. The line speed of the lamination was maintained at 150 mpm. The 24 hr bond of the laminate produced in this Trial 2 was a substrate failure bond resulting in the OPP film tearing apart.

### Example 3—Trial 3

A 15 μm unprinted OPP//70 gsm wovenPP tubular fabric was used in this Trial 3. The laminate was produced at a line speed of 150 mpm. The bond value after 24 hr was 220 g/15 mm to 270 g/15 mm with the substrate tearing off, i.e. OPP tears.

### Test Measurements

### Bond Values

The bond values for the laminates were obtained on a Universal testing machine by a T-type peel method in g/15 mm.

### Tear Values

The tear values for the laminates were obtained on a standard tear tester, where a notch is made in the laminate sample and the force required to tear away the laminate sample from the notch is measured.

### Drop Test

The laminates were subjected to a drop test, and rated as “pass” or “fail”, by manually dropping a sack made from the laminate from a height of 1.8 m, 6 times, on each side/surface of the sack.

### Test Results

Tables I, II, and III describe the results of comparative performance data of OPP/wovenPP laminates prepared by using extrusion and PACACEL™ solventless adhesive lamination routes. In the following tables, “OPP” means “oriented polypropylene (OPP) film”; “ex.PE” means “extrusion polyethylene film”; “adh” means “adhesive”; and “wwPP” means “woven polypropylene fabric”.

TABLE I
Bond Strengths of Laminates

| | Bond Value | Bond Value |
|---|---|---|
| | After 60 min | After 24 hr |
| Laminate Structure | (g/15 mm) | (g/15 mm) |
| Printed OPP/ex.PE/wwPP | 50-120, | 50-120, |
| | smooth peel | smooth peel |
| Unprinted OPP/ex.PE/wwPP | 60-180, | 60-180, |
| | smooth peel | smooth peel |
| Printed OPP/adh/wwPP | 80-100, | 200-230, |
| | smooth peel | OPP tears |
| Unprinted 12 μm OPP/adh/wwPP | 80-90, | 190-220, |
| | smooth peel | OPP tears |
| Unprinted 15 μm OPP/adh/wwPP | 80-100, | 190-230, |
| | smooth peel | OPP tears |

TABLE II
Tear Test Values in PE Extrusion Based Laminates

| | Force in | Force in |
|---|---|---|
| Laminate | Machine Direction | Transfer Direction |
| Structure | (mN) | (mN) |
| Printed | 35680, 46541, 37101, | 43401, 39641, 48146, |
| OPP/ex.PE/wwPP | 45720, 44926, 42700 | 49316, 37334, 39820 |
| Unprinted | 40657, 36157, 33015, | 41214, 43722, 44677, |
| OPP/ex.PE/wwPP | 40992, 49509, 33750 | 39886, 41214, 41436 |

TABLE III
Tear Test Values with Solventless Adhesive
PACACEL ™ 968/C-108

| | Force in | Force in |
|---|---|---|
| Laminate | Machine Direction | Transfer Direction |
| Structure | (mN) | (mN) |
| Printed | 45956, 49825, 45680, | 43401, 48146, 49316, |
| OPP/adh/wwPP | 46541, 37301, 36630 | 43401, 43401, 44720 |
| Unprinted 12 μm | 45305, 41637, 38525, | 42752, 61025, 49891, |
| OPP/adh/wwPP | 38525, 37947, 41637 | 45926, 46211, 44042 |
| Unprinted 15 μm | 44677, 43615, 55297, | 42752, 49891, 56211, |
| OPP/adh/wwPP | 43615, 41637, 45305 | 63907, 61025, 49891 |

Tables IV and V describe the results of performance data of OPP/wovenPP laminates prepared by using a regular solventless adhesive system, MOR-FREE™ 899A/C99, which failed to meet the desired requirements.

TABLE IV
Bond Strength Data

| | | Bond Value, |
|---|---|---|
| Laminate Structure | Time Interval | (g/15 mm) |
| Unprinted 12 μm OPP/adh/wwPP | 60 min bond | 0-20, smooth peel |
| Unprinted 12 μm OPP/adh/wwPP | 8 hr bond | 40-60, smooth peel |
| Unprinted 12 μm OPP/adh/wwPP | 24 hr bond | 40-60, smooth peel |

### Tear Values—Regular Solventless Adhesive

TABLE V
Tear Test Values with Solventless Adhesive
MOR-FREE ™ 899A/C99

| | Force in | Force in |
|---|---|---|
| Laminate | Machine Direction | Transfer Direction |
| Structure | (mN) | (mN) |
| Unprinted 12 μm | 39146, 31186, 29288, | 32275, 36688, 34564, |
| OPP/adh/wwPP | 32028, 32210, 32145 | 38028, 35567, 35439 |

### Discussion of Results

The appearance of the finished laminate made by the process of the present invention was acceptable, i.e., no visible defects were observed in the laminate. The 24 hr bond values of the laminate were also acceptable. The final bond values, tear values and drop test performance of sacks made with a laminate structure with PACACEL™ 968/C-108 solventless adhesive are better than the values observed when testing sacks made with a laminate structure that is made with a regular extrusion lamination process. The present invention allows an operator/converter to easily switch over to the solventless adhesive lamination process of the present invention for benefits of superior performance, economics and higher productivity. The bond and tear values obtained with a conventional solventless adhesive lamination process are significantly lower than those obtained with a conventional extrusion lamination process, and are insufficient to qualify for certain applications such as for heavy-duty packaging.

In the conventional extrusion-based laminate samples, the bond values vary considerably in the range of from 50 g/15 mm to 180 g/15 mm, and the resulting laminate structure exhibits a smooth peel. Using the solventless adhesive system of the present invention, the bond values of the laminate structure are more consistent; and the bond values can be as high as from 190 g/15 mm to 230 g/15 mm. Also, the resulting laminate structure exhibits OPP film tear. The tearing of the OPP film of the laminate structure, indicates that the actual bond values are even higher than the recorded value of 230 g/15 mm. The greater bond values of 230 g/15 mm or more is a major improvement in the integrity of the laminate as a unit structure.

The tack level in the PACACEL adhesive, after 2 hr of cure, is lower in intensity as compared to the tack level with the MOR-FREE adhesive at the same time interval. The difference in tack levels in the above two adhesives indicates that the PACACEL adhesive cures at a much higher rate compared to the MOR-FREE adhesive; and that the PACACEL adhesive will not easily permeate through the wovenPP fabric and onto the other side of the fabric, thereby maintaining an adhesive tie layer thickness for good bonding. In the case of the MOR-FREE adhesive, the tack level of the MOR-FREE adhesive, after 2 hr of cure, is higher than the PACACEL adhesive, indicating that the MOR-FREE adhesive cures at a slower rate than the PACACEL adhesive. The tacky MOR-FREE adhesive having a lower Mw can permeate through the uneven surface of a woven fabric under the internal pressure of the laminate roll. The permeation reduces the effective tie layer thickness, yielding further lower bond values, as observed.

In terms of tear values, the tear values of the extrusion laminate structure are around 42,000 mN; and the tear values of the adhesive laminate structure are around 44,000 mN. The resultant tear values indicate that both laminate structures are comparable in terms of tear-ability of the laminate. However, it is slightly more difficult to tear the adhesive laminated structure, since the tear values of the adhesive laminated structure are slightly higher than the tear values of the extrusion laminate structure.

Table VI describes the results of comparative performance data of OPP/wovenPP laminates prepared with each of the following processes: (1) extrusion lamination, (2) PACACEL™ 968/C-108 solventless adhesive lamination, and (3) MOR-FREE™ 899A/C99 regular solventless adhesive lamination.

TABLE VI
Comparative Performance Data

| | EXTRUSION | | | | | ADHESIVE USED: |
|---|---|---|---|---|---|---|
| | LAMINATION | | ADHESIVE USED: | | | MOR-FREE 899A/C99 |
| | (Control) | | PACACEL 968/C-108 | | | (Failure) |
| | Comp. Ex. A: | Comp. Ex. B: | Inv. Ex. 1: | Inv. Ex. 2: | Inv. Ex. 3: | Comp. Ex. C: |
| | Printed | Unprinted | Printed | Unprinted 12 μm | Unprinted 15 μm | Unprinted 12 μm |
| PROPERTIES | OPP/ex.PE/wwPP | OPP/ex.PE/wwPP | OPP/adh/wwPP | OPP/adh/wwPP | OPP/adh/wwPP | OPP/adh/wwPP |
| Bond value after | 50-120, | 60-180, | 80-100, | 80-90, | 80-90, | 0-20, |
| 60 min, g/15 mm: | smooth peel | smooth peel | smooth peel | smooth peel | smooth peel | smooth peel |
| Tack level after | No tack | No tack | Mild tack | Mild tack | Mild tack | Heavy tack |
| 2 hr: | | | | | | |
| Bond value after | 50-120, | 60-180, | 200-230, | 190-220, | 190-230, | 40-60, |
| 24 hr, g/15 mm: | smooth peel | smooth peel | OPP tears | OPP tears | OPP tears | Smooth peel |
| Tear test value | 42,111 | 39,013 | 43,655 | 40,596 | 45,691 | 32,667 |
| (MD*), mN: | | | | | | |
| Tear test value | 42,943 | 42,024 | 45,397 | 48,307 | 53,946 | 35,426 |
| (TD**), mN: | | | | | | |
| Properties of the | Extruded LDPE film has limited | | Adhesive has high cohesion, fast cure, | | | Adhesive has low |
| adhesive/tie layer: | adhesion to polypropylene (PP). | | excess high Mw polyester polyol | | | cohesion, slow cure, |
| | | | and high crosslinking density. | | | average polyester |
| | | | | | | content and low |
| | | | | | | crosslinking density. |
| Drop test | Passes | Passes | Passes | Passes | Passes | Fails |
| performance: | | | | | | |

Notes for Table VI:
*“MD” stands for “machine direction”.
**”TD” stands for ”transverse direction”.

What is claimed is:

1. A multi-layer laminate comprising:
(a) a first polyolefin film substrate layer;
(b) a second woven polyolefin fabric substrate layer; and
(c) a layer of a laminating adhesive composition disposed on the surface of at least one of the layers of (a) and (b) for binding layers (a) and (b).

2. The laminate of claim 1, wherein the first layer is a printed biaxially oriented polypropylene film layer.

3. The laminate of claim 1, wherein the second layer is a woven polypropylene layer or a woven high density polyethylene layer.

4. The laminate of claim 1, wherein the laminating adhesive composition is a two-component solventless polyurethane-based laminating adhesive including at least one isocyanate component and at least one polyol component.

5. The laminate of claim 4, wherein the isocyanate component is at least one aliphatic multi-functional isocyanate compound at a concentration of from 40 weight percent to 70 weight percent.

6. The laminate of claim 4, wherein the polyol component is at least one polyester polyol compound at a concentration of from 30 weight percent to 60 weight percent.

7. A process for producing a multi-layer laminate comprising the steps of:
(I) providing:
(a) a first polyolefin film substrate layer;
(b) a second woven polyolefin fabric substrate layer; and
(c) a laminating adhesive composition for binding layers (a) and (b) together;
(II) applying the adhesive composition from step (I) to at least a portion of the surface of at least one of the layers of the first and second substrate layers of step (I) to form an adhesive layer;
(III) combining the first and second substrate layers together with the adhesive layer, sufficient to form a multi-layer laminate; and
(IV) curing the structure of step (III) to form a cured multi-layer laminate.
